(19) United States
(12) Patent Application Publication
(10) Pub. No.: US 2018/0361646 A1
(43) Pub. Date: Dec. 20, 2018

(54) METHOD AND DEVICE FOR COOLING EXTRUDED PROFILES

(71) Applicant: battenfeld-cincinnati Germany GmbH, Bad Oeyenhausen (DE)

(72) Inventors: Heinrich Dohmann, Hoexter (DE); Henning Stieglitz, Minden (DE)

(21) Appl. No.: 15/576,728

(22) PCT Filed: Apr. 22, 2016
(86) PCT No.: PCT/EP2016/059025

§ 371 Date: Mar. 19, 2018

(30) Foreign Application Priority Data
Apr. 26, 2015 (DE) 102015106398.0

(51) Int. Cl. B29C 47/88; B29C 47/00; B29C 47/90

(52) U.S. Cl. CPC B29C 47/8815; B29C 47/90; B29C 47/003

(57) ABSTRACT

In an embodiment, the present invention provides a method for increasing the cooling performance of an extrusion line and for extruding a plastics profile, in particular a plastics tube, in an energy efficient manner, the method including the steps of: melting plastics material in an extruder; shaping a plastics strand and feeding the plastics strand to a die; shaping a plastics profile using the die; and calibrating and curing by cooling the profile in a cooling and/or calibration device, a gaseous medium being drawn through one or more cooling tanks in order to cool the outside of the profile. A temperature and a saturation of the gaseous medium is increased between an inlet region and an outlet region for the gaseous medium. A liquid medium is added between the inlet region and the outlet region using spray nozzles.

### CROSS-REFERENCE TO PRIOR APPLICATIONS

This application is a U.S. National Phase application under 35 U.S.C. § 371 of International Application No. PCT/EP2016/059025, filed on Apr. 22, 2016, and claims benefit to German Patent Application No. DE 10 2015 106 398.0, filed on Apr. 26, 2015. The International Application was published in German on Nov. 3, 2016 as WO 2016/173944 under PCT Article 21(2).

### FIELD

The invention relates to a method for increasing the cooling performance of an extrusion line and for extruding a plastics profile, in particular a plastics tube, in an energy efficient manner, which method comprises the steps of: a) melting plastics material in an extruder, b) shaping a plastics strand and feeding the plastics strand to a die, c) shaping a plastics profile by means of the die and d) calibrating and curing by means of cooling the profile in a cooling and/or calibration device, a gaseous medium being drawn through one or more cooling tanks in order to cool the outside of the profile. The invention also relates to a corresponding apparatus.

### BACKGROUND

Generic methods are already known from the prior art. For example, DE 24 55 779 describes a method for increasing the output performance during extrusion and proposes for this purpose the gaseous evaporation of a liquid medium on the inner surface of the profile. It is further disclosed that the air flow is intended to be guided counter to the extrusion direction.

In order to improve the heat dissipation, DE 10 2013 107 809 A1 also proposes that the cooling medium is guided over the interface to the plastics profile at such a high relative speed that a turbulent flow is produced here.

### SUMMARY

In an embodiment, the present invention provides a method for increasing the cooling performance of an extrusion line and for extruding a plastics profile, in particular a plastics tube, in an energy efficient manner, the method comprising the steps of: melting plastics material in an extruder; shaping a plastics strand and feeding the plastics strand to a die; shaping a plastics profile using the die; and calibrating and curing by cooling the profile in a cooling and/or calibration device, a gaseous medium being drawn through one or more cooling tanks in order to cool the outside of the profile, wherein a temperature and a saturation of the gaseous medium is increased between an inlet region and an outlet region for the gaseous medium, wherein a liquid medium is added between the inlet region and the outlet region using spray nozzles, and wherein the liquid medium is evaporated by heating and the saturation of the gaseous medium being increased.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a typical extrusion line,

FIG. 2 shows the part of a cooling zone,

FIG. 3 is a cross section of a cooling tank, and

FIG. 4 shows an alternative to FIG. 3.

### DETAILED DESCRIPTION

In an embodiment, the present invention provides a method in which the temperature and the saturation of the gaseous medium is increased between an inlet region and an outlet region for the gaseous medium, a liquid medium is added between the inlet region and the outlet region by means of spray nozzles, the liquid medium being evaporated by means of heating and the saturation of the gaseous medium being increased.

Efficient cooling of the profile is achieved by this method according to the invention. A gaseous medium, generally air (however, any other gas which is well suited to binding liquid can also be used, but air is mentioned here by way of example), is guided over the outside of the profile surface. Heat is then dissipated from the profile to the air via the profile surface. A liquid, generally water (any suitable liquid medium which evaporates at the known process temperatures is also conceivable here; however, water is discussed here as an example), is sprayed over a defined zone in the cooling zone. The water is already atomized in the heated air by means of the spraying, but the sprayed water also evaporates when it meets the surface of the profile. The air flowing through is heated, but can also thus absorb more water molecules and the saturation thereof increases. An impact on pressure is also conceivable since compressed air has a lower dew point (water condenses out while air becomes drier) than ambient air at normal pressure.

According to a development, however, it is ensured that the dew point is not exceeded and thus the water does not condense when the saturation is increased. The maximum saturation is therefore not achieved and the relative humidity remains less than 100%.

According to another development, additional air is drawn through additional openings in order to again reduce the degree of saturation of the air. The less saturated air is mixed with the more saturated air and the mixture is then once more capable of absorbing additional water molecules.

Advantageously, the amounts of water and the amounts of air are adjusted using a mathematical model such that an optimum amount of heat can be removed from the profile. This can be controlled in such a way that a temperature-control zone is also included. In this case, hardly any heat is removed from the profile in the extrusion direction, meaning that the heat can pass from the inner region, e.g. in thick-walled tubes, into the outer region. In this way, stresses and subsequently quality defects are prevented.

In another development, the approximately saturated air is cooled, for which purpose contact with the environment is often sufficient, meaning that no additional energy needs to be applied, as a result of which oversaturation occurs and the water condenses. The condensed water is recovered and supplied to the spray nozzles for reuse. The cooled air is then drier again and can also be recirculated to the inlet region.

According to a development, the air is additionally guided by means of deflector plates. The air flow can be influenced in a targeted manner by means of said deflector plates, the angle and rotation of which can be individually adjusted. The air can thus be guided over the surface of the profile closer to or further away from said surface or can be directed such that it flows helically around the profile. However, the installation of deflector plates in the form of funnels, as described in DE 10 2007 026 309 A1, is also conceivable. The content of DE '309 is thus part of the disclosure of this application.

An increase in heat dissipation can be achieved by the air being drawn through the cooling zone counter to the extrusion direction.

The proposed chambers can also be formed by a hollow body, the hollow body comprising chambers and partitions. However, it is also conceivable that an end of the partition forms the passage cross section for the profile and that the hollow body in the cooling tank can be replaced.

The method and the apparatus according to the invention are characterized in that the physical interaction of gas and liquid with respect to temperature and total pressure in conjunction with the vapor pressure is adjusted such that the equilibrium moisture content (the ratio of a mole of liquid to a mole of gas) is optimized, as a result of which the largest possible amount of heat can be dissipated.

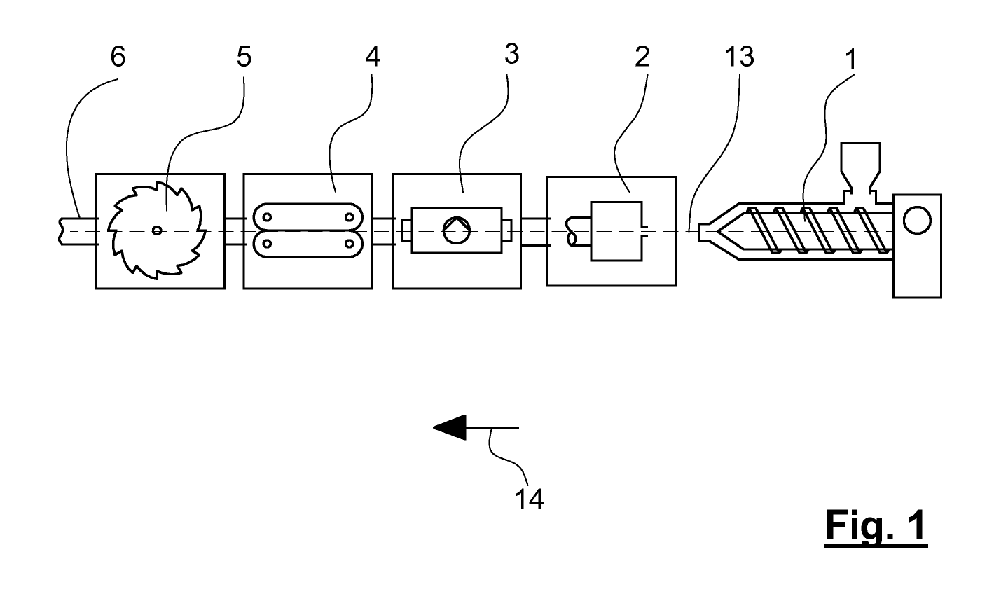

FIG. 1 shows a typical extrusion line, as used nowadays for profile extrusion, whether for the production of window profiles or tubes. Said figure shows an extruder 1, in which plastics material is melted and continuously conveyed into the extrusion die 2 for shaping. This is followed by a calibration and/or cooling device 3; additional cooling stations can be inserted depending on the profile. The cooling stations are followed by a puller 4. A cutter 5 is then arranged in order to cut the continuous profile 6 to the desired length.

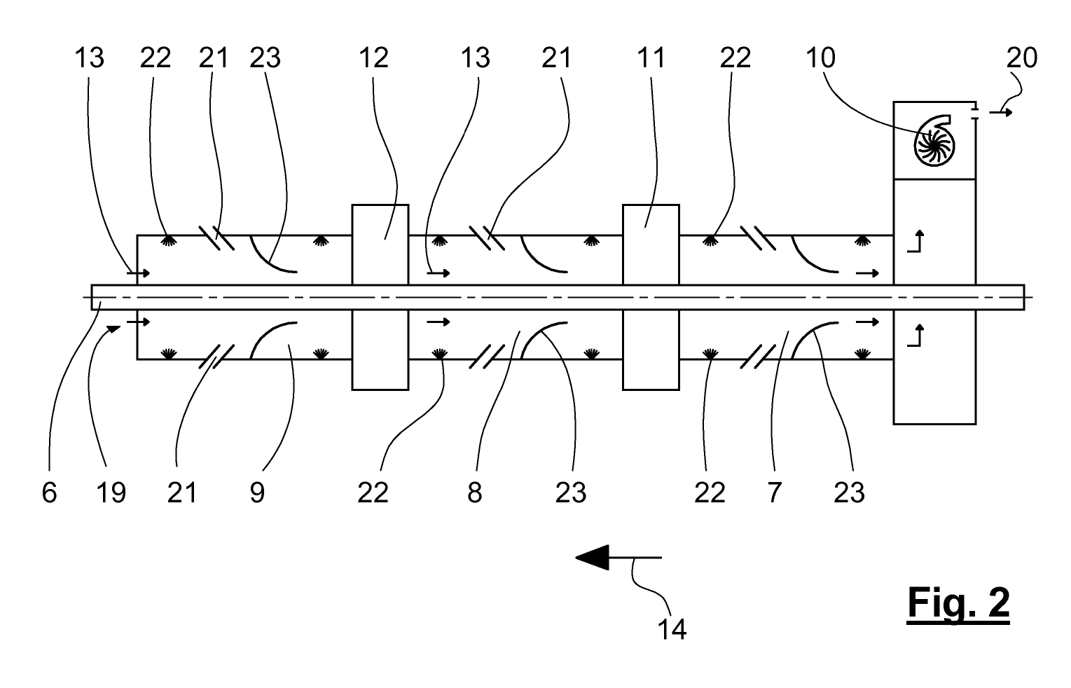

FIG. 2 shows a cooling zone comprising a first, second and third cooling tank (7, 8, 9). The cooling tanks are each connected by means of a connecting tunnel 11 and 12. The cooling zone comprises an inlet region 19 and an outlet region 20, through which the air can enter and leave. In this embodiment, the air is drawn in counter to the extrusion direction 14 by means of the suction device 10. The flow 13 is denoted by the arrows. Spray nozzles 22 are arranged in the cooling tanks 7, 8 and 9, by means of which nozzles water can be sprayed; corresponding feed lines are not shown. Each cooling tank further comprises additional openings 21 through which the additional air can be drawn. The openings can be opened and closed, which can also be carried out by means of the machine control system, e.g. in accordance with the mathematical model. Adjustable deflector plates 23 influence the flow 13 of the air and thus the distance by which and the manner in which said flow is guided around the profile 6.

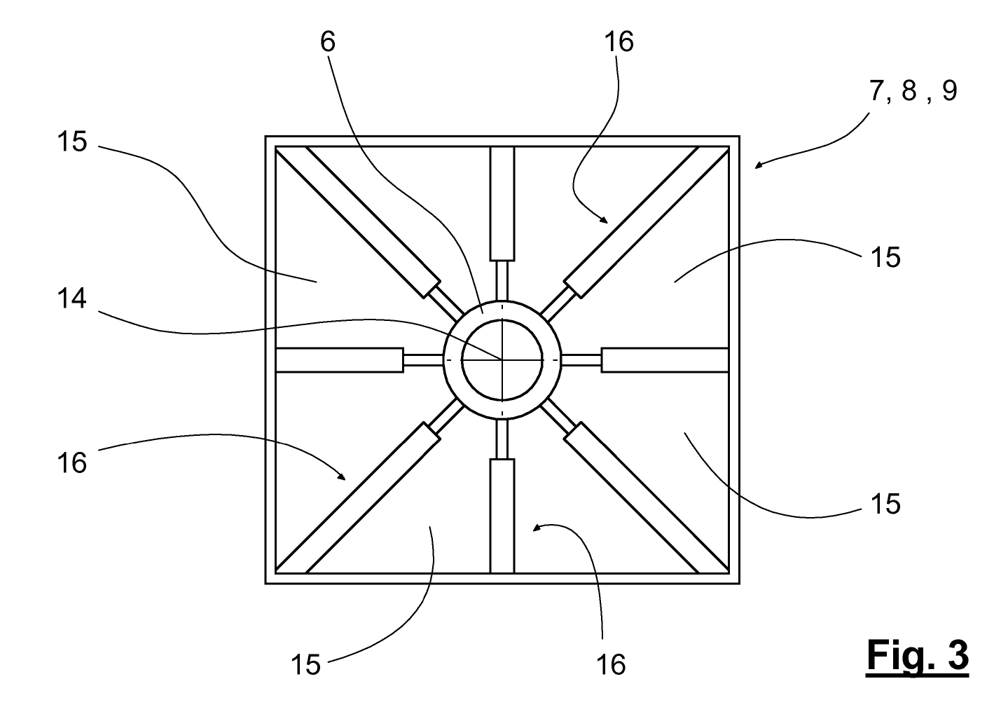

FIG. 3 shows a cross section of another embodiment of a cooling tank, transversely to the extrusion axis. The cooling tank is divided into chambers 15, which are formed by partitions 16. The partitions 16 are fastened to the wall of the cooling tank at one end and are variable in length at the other end such that different cross sections of the profile 6 can be cooled. The air for cooling is guided through the chambers 15, it being possible for the air to have a varying degree of flow through each chamber 15.

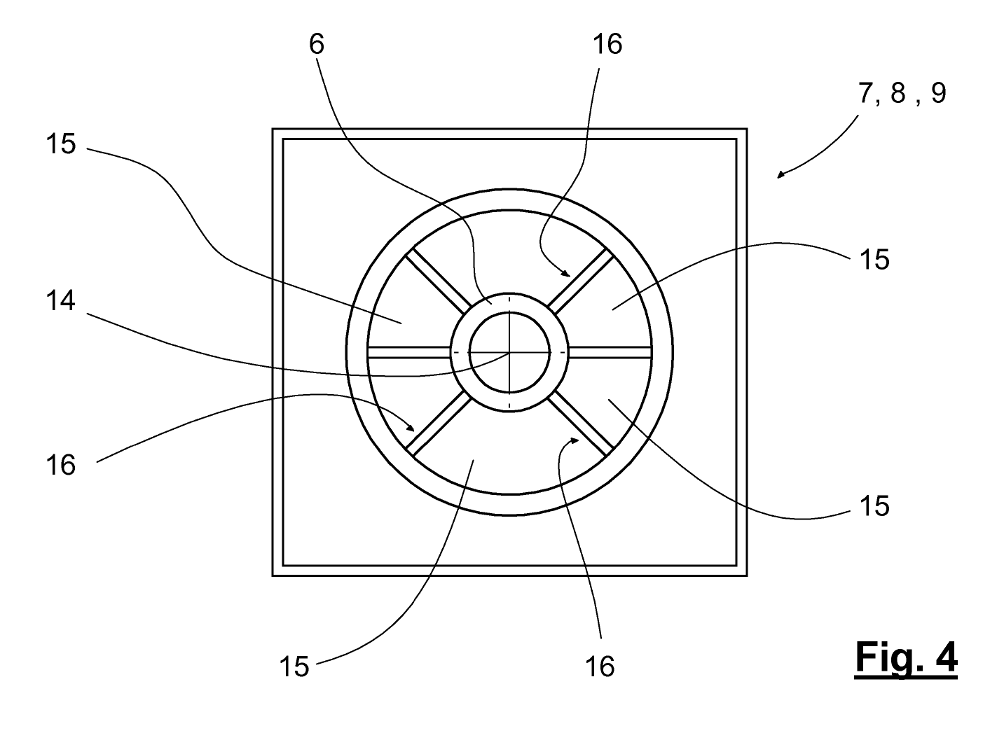

FIG. 4 shows an alternative to the embodiment according to FIG. 3. In this case, a fixed chamber system is used in the cooling tank, which system also comprises chambers 15 which are divided by partitions 16. The chambers 15 are of different sizes and the end of the partition 18 simultaneously forms the passage cross section for the profile 6.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 extruder
2 extrusion die
3 calibration and/or cooling device
4 puller
5 cutter
6 profile
7 first cooling tank
8 second cooling tank
9 third cooling tank
10 suction device
11 first connecting tunnel
12 second connecting tunnel
13 flow
14 extrusion direction
15 chamber in 7, 8 and/or 9
16 partition
17 . . .
18 end of 16
19 inlet region
20 outlet region
21 additional opening
22 spray nozzles
23 deflector plates

1. A method for increasing the cooling performance of an extrusion line and for extruding a plastics profile, in particular a plastics tube, in an energy efficient manner, the method comprising the steps of:
melting plastics material in an extrudeR;
shaping a plastics strand and feeding the plastics strand to a die;
shaping a plastics profile using the die; and
calibrating and curing by cooling the profile in a cooling and/or calibration device,
a gaseous medium being drawn through one or more cooling tanks in order to cool the outside of the profile,
wherein
a temperature and a saturation of the gaseous medium is increased between an inlet region and an outlet region for the gaseous medium,
wherein a liquid medium is added between the inlet region and the outlet region using spray nozzles, and
wherein the liquid medium is evaporated by heating and the saturation of the gaseous medium being increased.

2. The method according to claim 1, wherein a dew point of the gaseous medium is not exceeded when the saturation of the gaseous medium is increased.

3. The method according to claim 2, wherein additional gaseous medium is drawn through inlet openings.

4. The method according to claim 3, wherein an amount of gaseous medium and an amount of liquid medium sprayed is controlled using a mathematical model such that an optimum amount of heat is removed from a surface of the profile.

5. The method according to claim 1, wherein, after the gaseous medium has been drawn through one or more cooling tanks, it is cooled, causing oversaturation and the liquid medium to condense.

6. The method according to claim 5, wherein cooled gaseous medium is fed back to the inlet region and the liquid medium is fed to the spray nozzles.

7. The method according to claim 1, wherein the gaseous medium is fed around a surface of the profile by deflector plates.

8. The method according to claim 1, wherein the gaseous medium is drawn through one or more cooling tanks counter to an extrusion direction of the extruded plastics profile.

9. The method according to claim 1, wherein the gaseous medium is fed through one or more chambers of the cooling tank, it not being possible for the gaseous medium to pass from one chamber to an adjacent chamber.

10. An apparatus for increasing the cooling performance of an extrusion line and for extruding, in an energy-efficient manner, a plastics profile, in particular a plastics tube, comprising:
an extruder;
a die;
a calibration and cooling device; and
additional downstream devices,
wherein
the calibration and cooling device comprises at least one cooling tank,
wherein the calibration and cooling device comprises an inlet region through which a gaseous medium can be fed, and
wherein spray nozzles are arranged in at least one cooling tank, by which nozzles a liquid medium can be fed.

11. The apparatus according to claim 10, wherein additional openings are arranged in the cooling tank.

12. The apparatus according to either claim 10, wherein deflector plates are arranged in the cooling tank, which plates are individually adjustable.

13. The apparatus according to claim 10, wherein the cooling tank comprises one or more chambers through which a gaseous medium can be guided, the individual chambers being constructed such that gaseous medium is prevented from passing from one chamber to an adjacent chamber.

14. The apparatus according to claim 13, wherein the chambers are formed by partitions arranged in the cooling tank.

15. The apparatus according to claim 14, wherein the partitions are variable in length in a direction of an extrusion axis.
